(19) United States
(12) Patent Application Publication
(10) Pub. No.: US 2017/0190145 A1
(43) Pub. Date: Jul. 6, 2017

(54) SURFBOARD WAX WITH SUNSCREEN

(71) Applicant: Ryan Charles Ballenas, Auburn, MA (US)

(72) Inventor: Ryan Charles Ballenas, Auburn, MA (US)

(21) Appl. No.: 15/272,980

(22) Filed: Sep. 22, 2016

Related U.S. Application Data
(63) Continuation-in-part of application No. 15/083,464, filed on Mar. 29, 2016.
(60) Provisional application No. 62/272,971, filed on Dec. 30, 2015.

(51) Int. Cl. B32B 9/02; C09D 5/32; B29C 39/00; C09D 7/12; B32B 9/04; B29B 7/88; C09K 3/14; C09D 191/06

(52) U.S. Cl. CPC B32B 9/02; C09K 3/149; C09D 5/32; C09D 191/06; C09D 7/1233; C09D 7/1216; B32B 9/04; B29B 7/88; B29C 39/003; B32B 2250/02; B32B 2307/71; B32B 2605/00; B32B 2571/00; B29K 2091/00

(57) ABSTRACT

A composition includes a first layer of surfboard wax and a second layer of sunscreen. The second layer is adhered to the first layer so that the first and second layers are disposed above and below one another. The second layer includes a combination of a wax and an ultraviolet radiation absorber.

### CROSS-REFERENCE TO RELATED APPLICATION

This application is a continuation in part of U.S. non-provisional application Ser. No. 15/083,464, filed Mar. 29, 2016, which claims the benefit of priority of provisional application No. 62/272,971, filed Dec. 30, 2015, the contents of which are herein incorporated by reference.

### BACKGROUND OF THE INVENTION

The present invention relates to surf boarding and, more particularly, to surfboard wax with added sunscreen.

Waxed used on surfboards is a formulation of natural and/or synthetic wax, and other materials, for application to the deck of a surfboard, body board, or skim board, to provide traction in order to keep the surfer from slipping off the board when paddling in water, or riding a wave. It is also used to increase grip on the paddle of a surf kayak or dragon boat.

Conventional surfboard waxes suffer from the disadvantage that they render the surface of the surfboard unduly slick and slippery, making it difficult for the surfer to maintain contact with the board while surfing. Conventional surfboard waxes also lack being comprised of natural ingredients and are instead comprised of chemical ingredients, which could be environmentally detrimental. Further, surfers are susceptible to a sunburn due to the amount of time exposed the sun.

As can be seen, there is a need for an improved wax used on surfboards that includes sunscreen.

### SUMMARY OF THE INVENTION

In one aspect of the present invention, a composition comprises: a first layer comprising a combination of a wax and an ultraviolet radiation absorber; and a second layer comprising a surfboard wax adhered to the first layer.

In another aspect of the present invention, a method of forming a composition comprises: heating a wax to a liquid state; adding an ultraviolet radiation absorber to the liquid state of the wax forming a liquid wax sunscreen; pouring the liquid wax sunscreen into a mold; and allowing the liquid wax sunscreen to harden to a solid state forming a wax and sunscreen combination.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a schematic diagram with a flowchart illustrating a process of making the present invention;

FIG. 3 is a schematic diagram with a flowchart continuing the process of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a surfboard wax that may be made with natural ingredients and includes a top layer of sunscreen. The present invention prevents a person from slipping off of their surfboard and helps protect a person's skin from sunlight. The present invention creates a layer of adhesive when applied on a surfboard by using natural ingredients and has a layer of naturally made sunscreen.

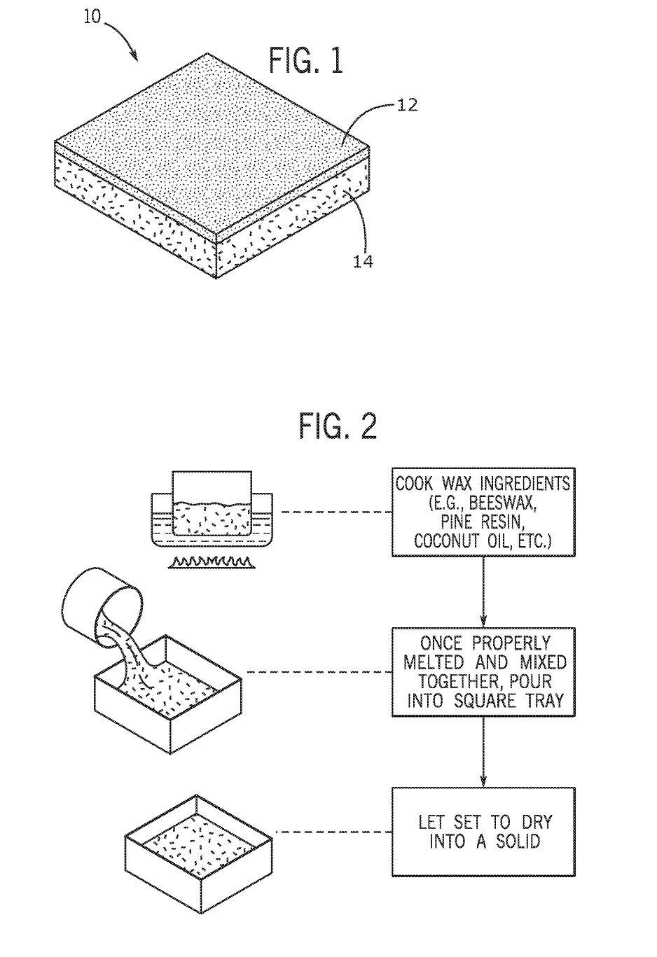

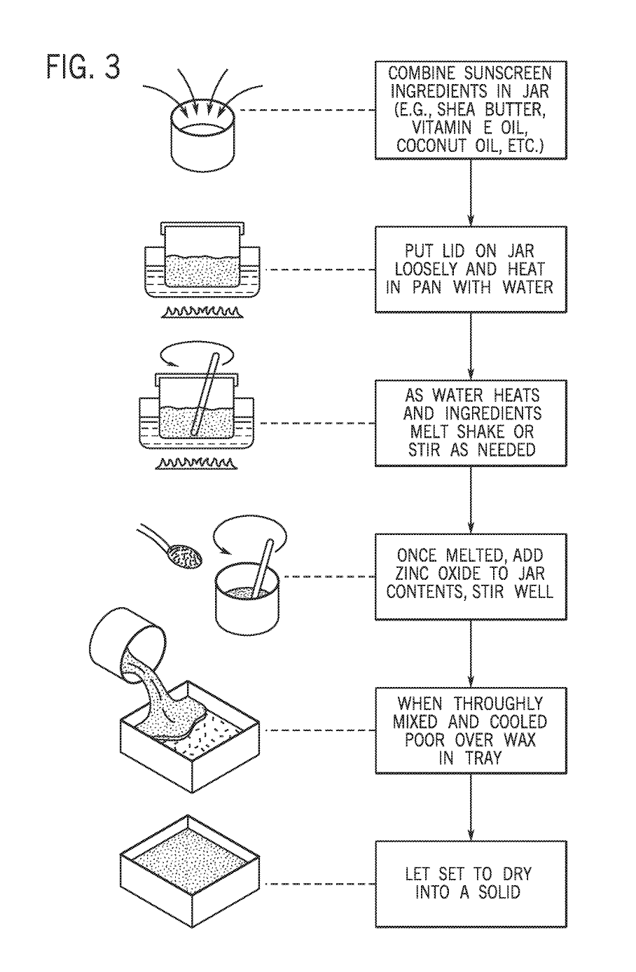

Referring to FIGS. 1 through 3, the present invention includes a composition 10 including a first layer 12 and a second layer 14. The first layer 12 includes a combination of a wax and an ultraviolet radiation absorber. The second layer 14 includes a surfboard wax. The second layer 14 is adhered to the first layer 12 so that the first and second layers 12, 14 are disposed above and below one another.

The surfboard wax of the second layer 14 may include a combination of beeswax, a pine resin and an oil. The oil may include, but is not limited to, neem oil, grape seed oil, avocado oil, hempseed oil or, preferably, coconut oil. The beeswax, pine resin, and oil when combined work together as an adhesive layer that creates grip between a person's feet and the upper surface of the surfboard.

As mentioned above, the first layer 12 includes a wax. The wax of the first layer 12 may also include beeswax. The first layer 12 may further include an oil, such as coconut oil hempseed oil, neem oil, rosehip oil, safflower oil, babassu oil, red raspberry seed oil, carrot seed oil, vitamin E oil, almond oil, grape-seed oil, jojoba oil, sunflower oil, sea buckthorn oil, marula oil, organ oil and shea butter. When combined, the oils listed above help protect a person's skin from harm caused by prolonged sunlight exposure and also promotes keeping a person's skin moisturized.

The ultraviolet radiation absorber of the first layer 12 is capable of absorbing the harmful effects of ultraviolet radiation which is non-irritating, non-toxic and is compatible with the ingredients used in the composition. The ultraviolet radiation can absorb UV light in the most damaging range of about 280-400 nm. The ultraviolet radiation absorber may include at least one of zinc oxide, para-aminobenzoic acid, 2-ethoxyethyl p-methoxycinnamate, diethanolamine p-methoxycinnamate, digalloyl trioleate, 2,2′dihydroxy-4-methoxybenzophenone, ethyl 4-[bis(hydroxypropyl)]aminobenzoate, 2-ethylhexyl salicylate, glyceryl aminobenzoate, 2-ethylhexyl 2-cyano-3,3-diphenylacrylate, ethylhexyl p-methoxycinnamate, 3,3,5-trimethylcyclohexyl salicylate, menthyl o-aminobenzoate, 2-hydroxy-4-methoxybenzophenone, amyl p-dimethylaminobenzoate, octyl p-dimethylaminobenzoate, 2-phenylbenzimidazole-5-sulfonic acid, 5-benzoyl-4-hydroxy-2 methoxbenzene sulfonic acid, triethanolamine salicylate, 4-tert. butyl-4-methoxy-dibenzoylmethane, and benzalphthalide.

The present invention further includes a method of making the composition. The method steps may include the following: heating a wax to a liquid state; adding an ultraviolet radiation absorber to the liquid state of the wax forming a liquid wax sunscreen; pouring the liquid wax sunscreen into a mold; and allowing the liquid wax sunscreen to harden to a solid state forming a wax and sunscreen combination. The method steps may further include the following: mixing the liquid state of the wax with the ultraviolet absorber forming a homogonous mixture prior to pouring the liquid wax sunscreen into the mold. The method steps may further include the following: heating a surfboard wax to a liquid state forming a liquid surfboard wax; and pouring the liquid surfboard wax into the mold. The liquid surfboard wax may be poured into the mold first and the liquid wax sunscreen is poured on top of the liquid surfboard wax once the liquid surfboard wax has hardened to a solid state. The method steps may further include the following adding at least one oil to the liquid state of the wax prior to pouring the liquid wax sunscreen into the mold. The solid surfboard wax sunscreen is then removed from the mold. To harden, the liquid surfboard wax and the liquid wax sunscreen are disposed in room temperature for about 2-3 hours

Three parts beeswax, one part coconut oil, and one part pine resin are melted together until homogeneity is obtained. In use, the mixture is coated onto the upper surface of a surfboard to a thickness of between about 3/16 inch to about ¾ inch to prevent slipping on the board. The wax sunscreen side is applied to the users skin to prevent sun damage.

### Example

Following the above procedure, from about ¼ to about 1 cup of beeswax (20%-40%) is placed in the inner container of a double boiler with water in the outer container. The water is brought to a slow boil for a time sufficient to completely melt the beeswax.

The following ingredients are then added to the melted wax:
1. about ¼-½ cup hempseed oil—49 grams/10%
2. about ¼ cup coconut oil—49 grams/10%
3. about 2-5 tablespoons zinc oxide (non-nano)—25 grams/5%
4. about ¼-½ cup neem oil—49 grams/10%
5. about 1-4 teaspoons rosehip oil—4 grams/1%
6. about 1-4 tablespoons safflower oil—12 grams/3%
7. about 1-4 tablespoons babassu oil—12 grams/3%
8. about 1-4 teaspoons red raspberry seed oil—4 grams/1%
9. about 1-4 teaspoons carrot seed oil—4 grams/1%
10. about 1 teaspoon vitamin E oil—4 grams/1%
11. about 2 tablespoons Shea Butter—29 grams/6%
12. about 1-4 teaspoons jojoba oil—4 grams/1%
13. about 1-4 tablespoons grapeseed oil—12 grams/3%
14. about 1-4 tablespoons sunflower oil—12 grams/3%
15. about 1-4 teaspoons sea buckthorn oil—4 grams/1%
16. about 1-4 teaspoons marula oil—4 grams/1%
17. about 1-4 teaspoons argan oil—4 grams/1%
18. about ½ cup almond oil—49 grams/10%

The mixture is stirred until the composition attains homogeneity. It is then set aside at room temperature to cool. The resulting mixture has the consistency of a lotion which may be readily applied to the skin.

Those skilled in the art will appreciate that the amounts of the above ingredients may be changed in order that the consistency of the final composition reaches the desired level. For example, the use of more natural wax results in a final composition having a more solid paste-like consistency, whereas lessening the amount of natural wax reduces the consistency to that of an oil or lotion

It should be understood, of course, that the foregoing relates to exemplary embodiments of the invention and that modifications may be made without departing from the spirit and scope of the invention as set forth in the following claims.

What is claimed is:

1. A composition comprising:
a first layer comprising a combination of a wax and an ultraviolet radiation absorber; and
a second layer comprising a surfboard wax adhered to the first layer.

2. The composition of claim 1, wherein the surfboard wax comprises a beeswax, a pine resin, and an oil.

3. The composition of claim 2, wherein the oil is selected from the group consisting of coconut oil and hempseed oil.

4. The composition of claim 1, wherein the wax of the first layer is a beeswax.

5. The composition of claim 1, wherein the combination of the first layer further comprises at least one oil.

6. The composition of claim 5, wherein the at least one oil comprises coconut oil hempseed oil, neem oil, rosehip oil, safflower oil and babassu oil.

7. The composition of claim 6, wherein the at least one oil further comprises red raspberry seed oil, carrot seed oil, vitamin E oil, almond oil, grape-seed oil, jojoba oil, sunflower oil, sea buckthorn oil, marula oil, organ oil and shea butter.

8. The composition of claim 1, wherein the ultraviolet radiation absorber is selected from the group consisting of zinc oxide, para-aminobenzoic acid, 2-ethoxyethyl p-methoxycinnamate, diethanolamine p-methoxycinnamate, digalloyl trioleate, 2,2′dihydroxy-4-methoxybenzophenone, ethyl 4-[bis(hydroxypropyl)]aminobenzoate, 2-ethylhexyl salicylate, glyceryl aminobenzoate, 2-ethylhexyl 2-cyano-3,3-diphenylacrylate, ethylhexyl p-methoxycinnamate, 3,3,5-trimethylcyclohexyl salicylate, menthyl o-aminobenzoate, 2-hydroxy-4-methoxybenzophenone, amyl p-dimethylaminobenzoate, octyl p-dimethylaminobenzoate, 2-phenylbenzimidazole-5-sulfonic acid, 5-benzoyl-4-hydroxy-2 methoxbenzene sulfonic acid, triethanolamine salicylate, 4-tert. butyl-4-methoxy-dibenzoylmethane, and benzalphthalide.

9. A method of forming a composition comprising:
heating a wax to a liquid state;
adding an ultraviolet radiation absorber to the liquid state of the wax forming a liquid wax sunscreen;
pouring the liquid wax sunscreen into a mold; and
allowing the liquid wax sunscreen to harden to a solid state forming a wax and sunscreen combination.

10. The method of claim 9, further comprising the step of:
mixing the liquid state of the wax with the ultraviolet absorber forming a homogonous mixture.

11. The method of claim 9, further comprising the steps of:
heating a surfboard wax to a liquid state forming a liquid surfboard wax; and
pouring the liquid surfboard wax into the mold.

12. The method of claim 11, wherein the liquid surfboard wax is poured into the mold first and the liquid wax sunscreen is poured on top of the liquid surfboard wax once the liquid surfboard wax has hardened to a solid state.

13. The method of claim 11, wherein the surfboard wax comprises a beeswax, a pine resin, and an oil.

14. The method of claim 13, wherein the oil is selected from the group consisting of coconut oil and hempseed oil.

15. The method of claim 9, wherein the wax is a beeswax.

16. The method of claim 9, further comprising the step of:
adding at least one oil to the liquid state of the wax prior to pouring the liquid wax sunscreen into the mold.

17. The method of claim 16, wherein the at least one oil comprises coconut oil hempseed oil, neem oil, rosehip oil, safflower oil and babassu oil.

18. The method of claim 17, wherein the at least one oil further comprises red raspberry seed oil, carrot seed oil, vitamin E oil, almond oil, grape-seed oil, jojoba oil, sunflower oil, sea buckthorn oil, marula oil, organ oil and shea butter.

19. The method of claim 9, wherein the ultraviolet radiation absorber is selected from the group consisting of zinc oxide, para-aminobenzoic acid, 2-ethoxyethyl p-methoxycinnamate, diethanolamine p-methoxycinnamate, digalloyl trioleate, 2,2′dihydroxy-4-methoxybenzophenone, ethyl 4-[bis(hydroxypropyl)]aminobenzoate, 2-ethylhexyl salicylate, glyceryl aminobenzoate, 2-ethylhexyl 2-cyano-3,3-diphenylacrylate, ethylhexyl p-methoxycinnamate, 3,3,5-trimethylcyclohexyl salicylate, menthyl o-aminobenzoate, 2-hydroxy-4-methoxybenzophenone, amyl p-dimethylaminobenzoate, octyl p-dimethylaminobenzoate, 2-phenylbenzimidazole-5-sulfonic acid, 5-benzoyl-4-hydroxy-2 methoxbenzene sulfonic acid, triethanolamine salicylate, 4-tert. butyl-4-methoxy-dibenzoylmethane, and benzalphthalide.
